(19) United States
(12) Patent Application Publication
(10) Pub. No.: US 2014/0045523 A1
(43) Pub. Date: Feb. 13, 2014

(54) METHODS AND APPARATUS FOR TRACKING LOCATION OF PORTABLE ELECTRONIC DEVICE

(71) Applicants: Amandeep Singh, Pickering (CA); James W. Wills, Halifax (CA)

(72) Inventors: Amandeep Singh, Pickering (CA); James W. Wills, Halifax (CA)

(73) Assignee: ENDRELIA TECHNOLOGIES INC., Toronto (CA)

(21) Appl. No.: 13/983,211

(22) PCT Filed: Feb. 3, 2012
(86) PCT No.: PCT/CA12/50062

§ 371 Date: Oct. 15, 2013

Related U.S. Application Data
(60) Provisional application No. 61/439,057, filed on Feb. 3, 2011.

(51) Int. Cl. H04W 4/02; H04W 4/22

(52) U.S. Cl. CPC H04W 4/028; H04W 4/22
USPC 455/456.1

(57) ABSTRACT

The disclosure is directed at a method of determining a location of a user associated with a portable electronic device comprising obtaining a list of addresses associated with the user; comparing the list of addresses with predetermined criteria; and determining addresses within the list of addresses which fit the predetermined criteria.

### CROSS-REFERENCE OF CORRESPONDING APPLICATIONS

This application claims the benefit of U.S. Provisional Patent Application No. 61/439,057, filed Feb. 3, 2011, which is incorporated herein by reference.

### FIELD OF DISCLOSURE

The disclosure is generally directed at location modelling and more specifically at methods and apparatus for tracking location of a portable electronic device.

### BACKGROUND OF THE DISCLOSURE

When emergencies occur, the time to respond and rescue an individual may be short. Depending on the emergency, the individual's life or health may be in imminent danger and therefore, emergency personnel may be required to respond immediately. In many cases, if the individual is able to communicate their location to the emergency personnel operator, the emergency personnel may be quickly dispatched to the emergency site. However, there may be occasions where the individual may not be able to communicate their location.

In some professions, the location of an employee may not be easily determined especially where employees are continuously going to meetings out of the office or are not necessarily required to be in the office at all times. This may also apply to individuals in general. In many emergency scenarios, the presence of the employee may be ascertained by looking at their calendars or by contacting them directly, such as by calling them or contacting them via their portable electronic device. However, in some cases the user may not be able to respond to attempts to contact him/her.

In some emergencies, the emergency call is made using a portable electronic device. Unlike the wireline system where the location of the telephone is known, the location of a portable electronic device, or user, is not always clearly known. If a user has made a call in peril, but is unable to communicate the location, it is difficult to send assistance or for emergency personnel to locate the individual.

To address this problem, several technologies exist that locate a user without having to communicate verbally. Technologies such as Global Positioning (GPS), and cell tower triangulation are commonly available methods. In some solutions, cell tower location technology is combined with GPS to get a faster and more accurate lock on a user's location, however, when the user is indoors these methods often give an approximate general location of the user because the portable electronic device is unable to transmit or receive clear GPS signals. Even if the portable electronic device does get an accurate lock, the exact suite in a building may still be unknown. As a result it is difficult to find the employee's exact location and to send assistance. Another common way users address this location tracking issue is by leaving a

“Location Note,” or “Amber Alert”. For example the user can record a voice note “10174 Sheppard Ave E, Toronto” on a server, or transmit an address to a server before going into a location. When an emergency call comes in, this address is retrieved and assistance is dispatched to that location. However the problem with this approach is that it is cumbersome for the user to do this every time he or she goes to a new location.

Therefore, there is provided novel methods and apparatus for tracking location of a portable electronic device.

### SUMMARY OF THE DISCLOSURE

The disclosure is directed at methods and apparatus for locating a portable electronic device. This method finds benefit in emergency scenarios where an individual who is experiencing the emergency is unable to communicate their location to another individual, such as, but not limited to, an emergency personnel operator. Therefore, one advantage of the current method is that a portable electronic device associated with the user may be located which may assist people, such as emergency personnel, in locating the individual in order to attempt to rescue the individual.

The method includes the collection of locations, such as addresses where the individual is known to frequently visit or associated with the individual in various scenarios, such as, but not limited to, appointments for meetings, their office, their home, their dentist, or may be based on the collection of location co-ordinates where the user visits on a frequent basis. The collection of addresses or co-ordinates is then compared with a last known location co-ordinate or radius focus point to determine which of the addresses or locations are within predetermined criteria of the last known location.

In one aspect of the disclosure, there is provided a method of determining a location of a user associated with a portable electronic device comprising obtaining a list of locations associated with the user, comparing the list of locations with predetermined criteria, and determining locations within the list of locations which fit the predetermined criteria.

### BRIEF DESCRIPTION OF THE DRAWINGS

The disclosure will now be described in detail, with reference to the accompanying drawings of preferred and exemplary embodiments, in which:

FIG. 1 is a flowchart outlining a method for locating a portable electronic device;

FIG. 2 is a flowchart of a weighting system for use with the method of FIG. 1;

FIG. 3 is a flowchart of another embodiment of a method for locating a portable electronic device;

FIGS. 4a to 4d are schematic maps for use with a display; and

FIG. 5 is a flowchart outlining a method for generating a list of location coordinates.

### DETAILED DESCRIPTION

The disclosure is directed at methods and system for locating a portable electronic device. In one embodiment, the method and system is directed at locating a portable electronic device associated with an individual during an emergency situation when the individual is unable to disclose their location to an individual such as an emergency operator. The method, apparatus and system may be enhanced by the collection of locations associated with the individual for use by the operator, however, the method and system may also operate if locations are collected in a database and stored.

The method and system may provide further information to the operator regarding the whereabouts of the individual such that the chance of rescue of the individual may be increased. Especially in scenarios where the individual is unconscious or unable to verbally communicate over the portable device, the current method and system may provide information that might not be otherwise available to the operator.

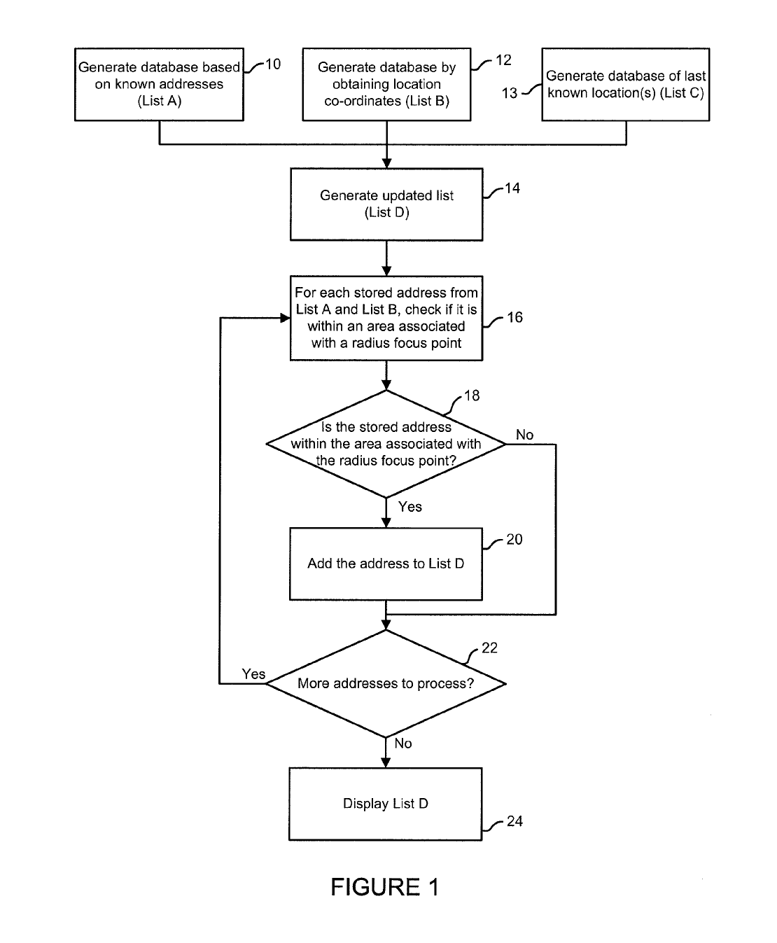

Turning to FIG. 1, a method of gathering information for use in locating a portable electronic device is shown, for instance in an emergency situation. By locating the portable electronic device which is associated with the individual, or employee, this may allow emergency personnel to more quickly arrive at the user's location.

As discussed above, to enhance the method, apparatus and system, although not a necessary part, a database may be created, or generated (10) which includes a list of expected or known addresses, or locations (List A) where the employee may be expected to be found. This may include, but is not limited to, regularly visited locations or locations which are included in their calendar. For instance, if the employee is a real estate agent, the list of known addresses may include each of the pieces of real estate that the employee is hoping to sell. In another example, if the employee is a home care nurse, the list of known addresses may include the addresses of all the patients that the employee cares for. The database may also be generated via input such as from an email, via user input through a browser plug in, by logging into a user's account, by retrieving the addresses from contact information, retrieving addresses from calendar appointments or via a text message. Other known methods of populating a database or list may also be used.

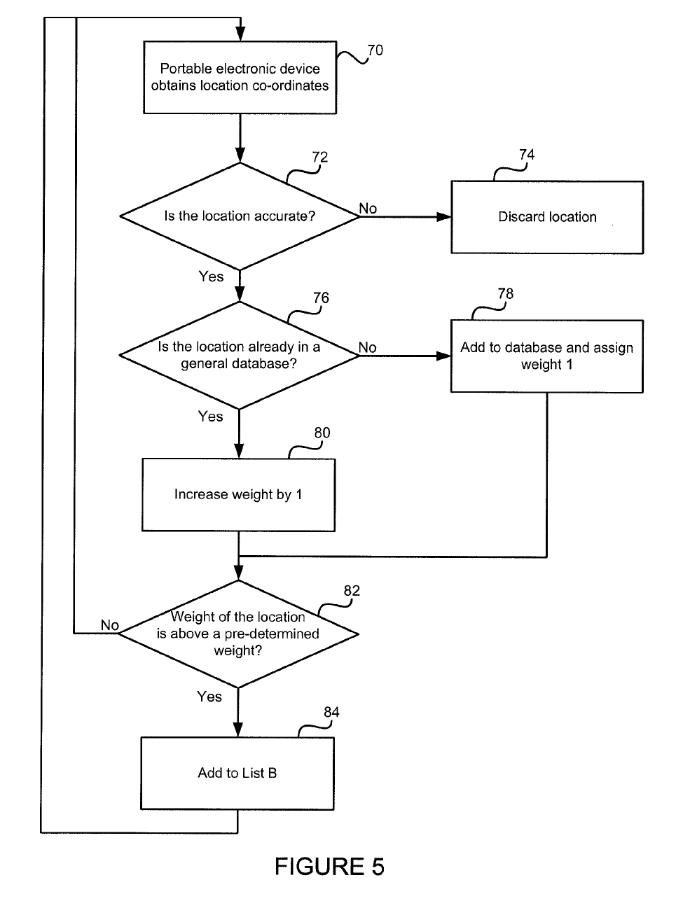

In another embodiment, or within the same embodiment, a second list of locations, such as geographic addresses or location co-ordinates (List B) may be generated based on the user's movements. The location co-ordinates from List B and the addresses from List A may be seen generally, as locations. These location co-ordinates may be obtained by using technologies such as, but not limited to, GPS technology, cellular triangulation technology, or WiFi router identification technology. Therefore, as a user continues to move from location to location, regular retrieval of location information or co-ordinates may be performed and then stored in List B. A weighting algorithm, such as the one discussed below, may be implemented to provide a higher weighting to geographic addresses or location co-ordinates which are regularly retrieved by the system and stored but may not be a part of List A. An example of how to generate List B is shown in FIG. 5.

Turning to FIG. 5, the portable electronic device obtains a location co-ordinate representing where the user is currently located (70). A check is then performed to determine if the location co-ordinate may be considered accurate (72). For example, the location co-ordinate provided by GPS technology may have an accuracy within 500 m. This location co-ordinate would likely not be of benefit to the emergency personnel operator as even with this location co-ordinate there is still a relatively big area to cover for emergency personnel to locate the user. Therefore, if the location co-ordinate is not considered accurate, it is discarded or not stored (74). If the location co-ordinate is deemed to be accurate, the location co-ordinate may be stored in a database. In one embodiment, all the location co-ordinates, preferably the location co-ordinates deemed accurate, may be stored in a general database.

A check is then performed to determine if the location co-ordinate has already been stored in the database (76). If the location co-ordinate is a new location co-ordinate, it is added to the database and assigned a weighting of 1 (78). If the location co-ordinate is already in the general database, its weighting is increased by 1 (80).

In one embodiment, if one location co-ordinate is in close proximity to a second location co-ordinate and if the second co-ordinate is within the accuracy range of the first co-ordinate, or vice-versa, the two location co-ordinates may be seen as the same location co-ordinate.

After the weighting has been updated, a check is performed to see if the weight of the location co-ordinate is above a predetermined value or weight (82). If the weight of the location co-ordinate is above the predetermined weight, the location co-ordinate is added to List B (84). The next location co-ordinate is obtained by the portable electronic device. In this manner, only the locations regularly visited are stored in List B.

Although not necessary, an algorithm may be applied to the location co-ordinates in the general database to continuously remove location co-ordinates that are not regularly visited by the user.

While the addresses in List A and location co-ordinates in List B are collected, another database including a list of last known locations or location co-ordinates (List C) is also created. The last known locations may also be seen as a radius focus point. These last known locations or location co-ordinates may also be obtained by using technologies such as, but not limited to, GPS technology, cellular triangulation technology, WiFi router identification technology or cell tower identification technology. In this list (List C), the locations may not be permanently stored but are stored to understand the last known location or locations of the user. Therefore, as the last known location of the user is known, older location information may be removed from the list. Removal of this location information may be based on criteria such as, but not limited to, the length of time the location information has been stored in the list. Alternatively, List C may only include a single location as it may be determined that only the individual's most recently known location is necessary or required.

In order to maintain an updated list as to the possible whereabouts of the individual, another list may be generated (List D) (14) based on a comparison between List A and List B with List C. In a preferred embodiment, Lists A, B and C are dynamic lists which are regularly updated as new address or location information is obtained or received by the portable electronic device or the server. List D is also dynamic as it is continuously being updated based on the user's last known location (List C). In a preferred embodiment, each of the lists is stored on a server and associated with the portable electronic device so that it may be transmitted to or reviewed by an individual such as the emergency operator, when necessary.

Based on this information, a more definite determination or understanding of the user's location both address-wise and also their location within a building may be ascertained based on the possible benefit of apartment or suite information.

In order to generate List D, each of the addresses which are stored in Lists A and B are compared with the most recent geographical location information or last known location (List C) (16). In one embodiment, the last known location may be seen as a radius focus point. If any of the stored addresses in List A or the geographic locations or location co-ordinates in List B is within an area associated with the radius focus point, such as within a 3 km radius of the radius focus point (18), the stored address from List A or the geographic locations or location coordinates in List B is included in the updated list (List D) of current possible locations (20). Therefore, if an emergency situation occurs and the user cannot be located accurately, reference can be made to List D to narrow the list of possible locations where the user may be found. Therefore, once the address has been added to List D or if the stored address is not within the area associated with the radius focus point, a check is performed to see if there are further addresses in List A or List B to process (22). When necessary, such as when an emergency situation is signalled but the employee, or user is not able to provide an indication of their location, the list of possible locations may be displayed (24).

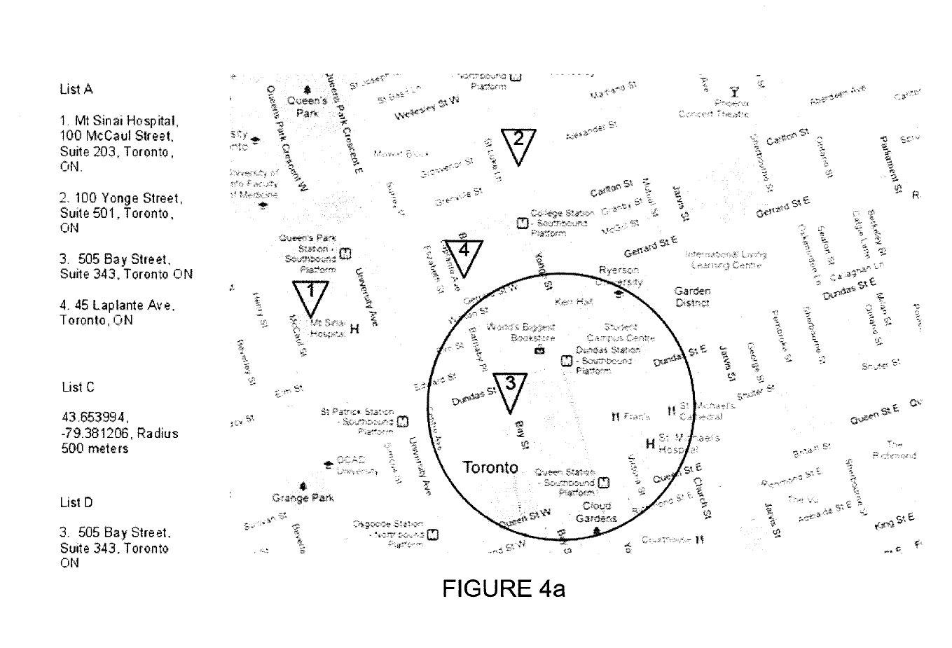

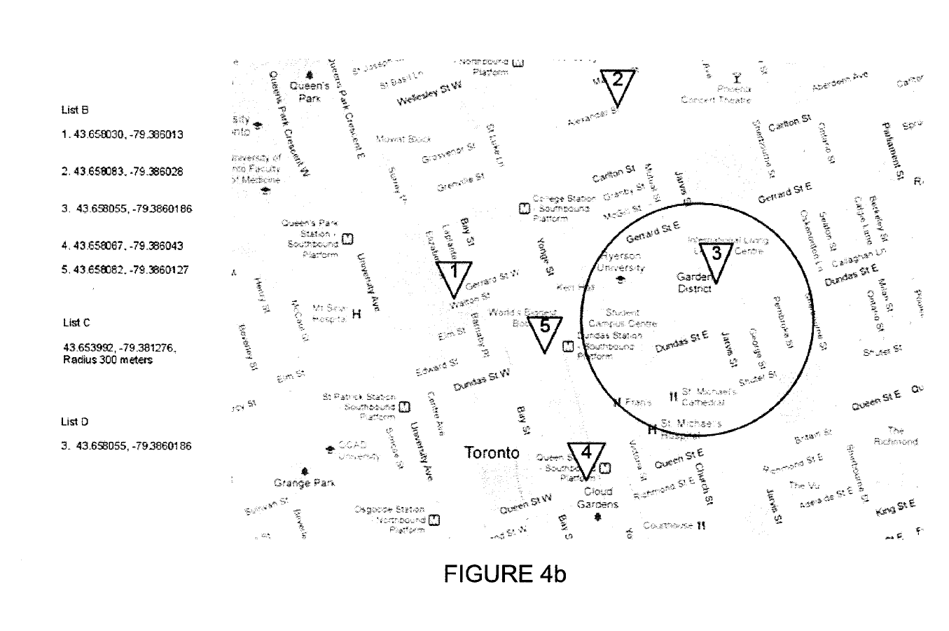

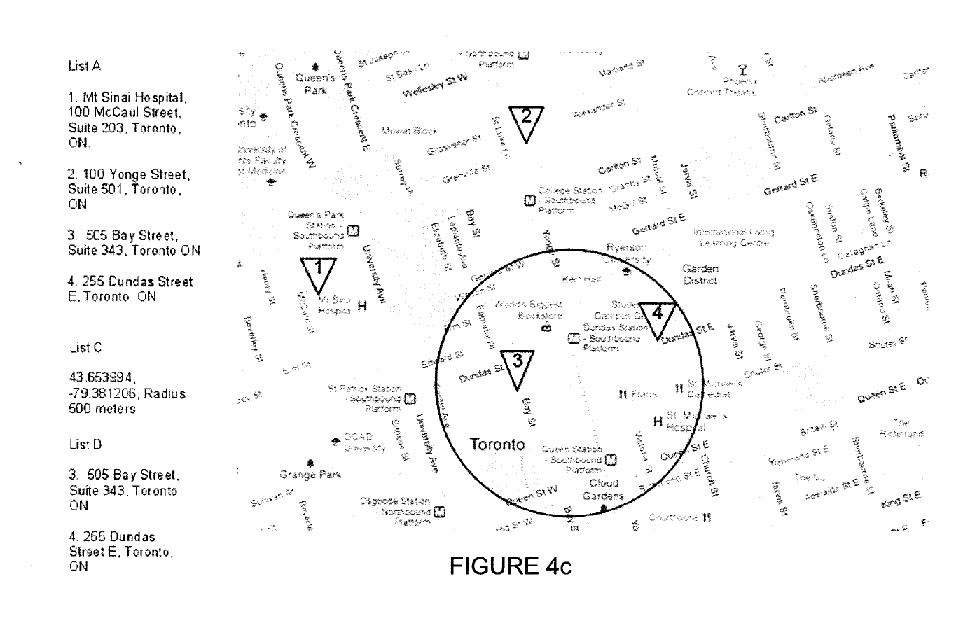

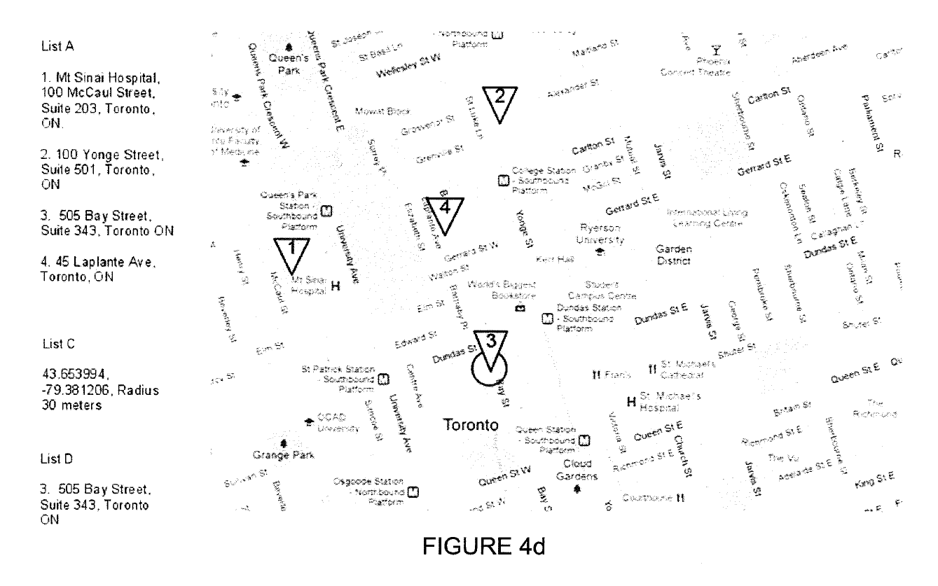

FIGS. 4a to 4d provide examples of display screens showing a location such as an address or a location co-ordinate which is within an area associated with a radius focus point, or, in other words, a display of the addresses or co-ordinates which are found in List D. Although shown to the side of the display, in other embodiments, the List A, List B, List C and List D information may not be shown. Lists C and D may be used to indicate the individual's last known position and known locations in close proximity to the last known position, so that by reviewing List D, an understanding of the user's probable location or locations may be determined.

In an alternative embodiment, List D is regularly updated once the location information or radius focus point, is changed in List C so that List D may provide an updated version so that operators have current information for their dispatch. More specifically, this updated information may allow an emergency personnel operator to more quickly instruct emergency personnel to the individual's location during the emergency. In one embodiment, the emergency operator accesses a server which stores List D associated with a portable electronic device to determine where to send emergency personnel. In another embodiment, the List D information may also be stored or displayed on the portable electronic device as well so that the user can track the information being stored in the server.

In one embodiment, if the determined location is an apartment complex or a business building with multiple suites, a review of the List D addresses may assist the emergency operator, or emergency personnel in finding the actual apartment or suite number for the individual's location.

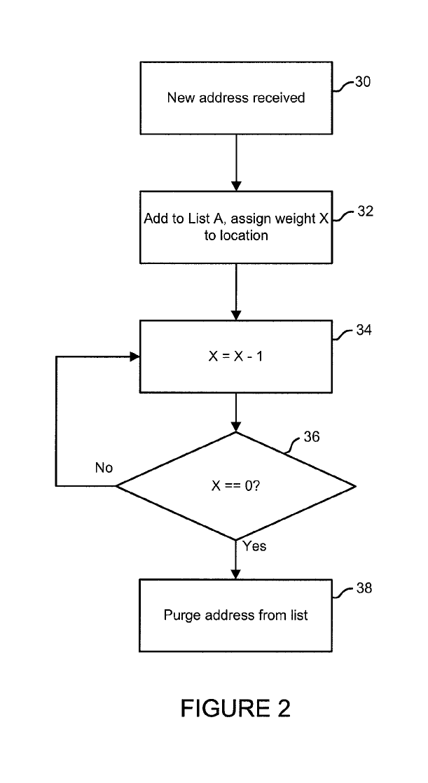

In another embodiment, if the individual is always adding new locations to List A, List A can grow large and subsequently the number of addresses which are in List D may be more than a predetermined number. In order to improve the benefit of List D for the operator, List D should have as few addresses as possible, and preferably only one. Therefore, certain weighting for the addresses in List A, List B or List D may be added to limit the number of entries in List D. An example of such a weighting is shown in FIG. 2.

When the new address for List A is received (30), the address is added to the list and a predetermined weighting (X) is applied to the new address (32). After a predetermined period of time, the weighting is updated to be X=X−1 (34). A check is then performed to determine is X=0? (36). If X does not equal, X may then be decreased by 1 again (34) either immediately or after a predetermined period of time which may be the same or may be different from the previous period of time. If X=0, the address may be purged from List A (38).

In an alternative embodiment, each time the individual visits a location in List A, the value of X may be increased by 1 or by a chosen value. In this manner, locations which are regularly visited by the individual remain in List A without the need to have the address re-entered each time. This weighting algorithm may also be beneficial for the collection of locations in List B.

In yet a further embodiment, weighting of the addresses in List A may also be implemented based on the reliability of the source from which the address is received. If the location comes from a less reliable source, it may be assigned a lower weighting value. For example, a location received from an application that keeps track of the user's agenda or calendar may be less reliable than a location directly received from the user.

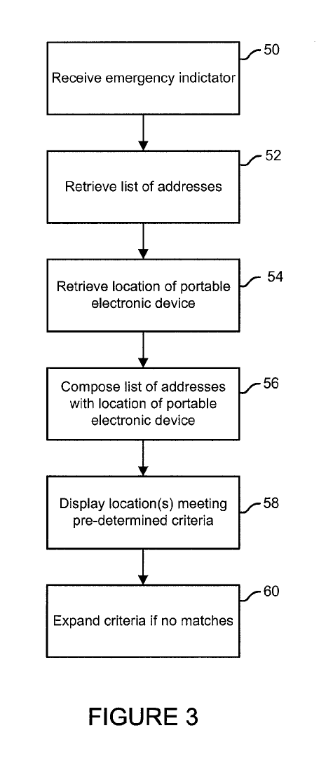

Turning to FIG. 3, a flowchart outlining another method of tracking location of a portable electronic device is shown. It is assumed that the portable electronic device is associated with an individual who is in an emergency scenario and unable to provide an operator with their actual location. Since this is an emergency situation, assistance may be urgently required and time may be limited.

After it is determined that there is a need to locate the user, or an indication that a user is experiencing an emergency scenario (50), a set of locations associated with the individual is retrieved (52). As discussed above, this information may be retrieved from a server by the operator. In a preferred embodiment, the information from at least List D is regularly updated by the portable electronic device to a server or by other systems processors which communicate with this server. Examples of systems include, but are not limited to, cell towers, WiFi routers or GPS location systems. This set of locations is preferably continuously generated as outlined above with respect to List A. In an alternative embodiment, the information from List A and List B may be continuously updated on the server.

In one embodiment, the location of the portable electronic device is retrieved from the device (54). The location information or radius focus point may be generated by a GPS signal from the device or via communication with a cell tower which has recently communicated with the portable electronic device. The location information is then compared with the list of address locations so that possible locations of the individual may be narrowed or determined (56). After determining which locations in the list fit predetermined criteria, such as within a certain area associated with the radius focus point of the device's location, the set of locations may then be displayed (58). Alternatively, if there are no locations in the list which correspond to the predetermined criteria, the radius, or the predetermined criteria may be expanded to include other parameters (60).

In one embodiment, when there is a need to locate the user, and the electronic device may not be turned on or in operation, a check may be performed to determine the last cell tower which had contact with the user's portable device. This does not mean the last cell tower from which a call was made (as there may be a large time frame since that call) but as a portable electronic device passes a cellular tower, at least one signal is transmitted to locate the closest cell tower to provide a known location. Based on this last communication between the portable device and a cellular tower network, the radius or predetermined criteria may be applied to that tower as the focus point.

The above-described embodiments are intended to be examples only. Those of skill in the art can effect alterations, modifications and variations to the particular embodiments without departing from the scope of this application.

1. A method of determining a location of a user associated with a portable electronic device comprising:
obtaining a list of locations associated with the user;
comparing the list of locations with predetermined criteria; and
determining locations within the list of locations which fit the predetermined criteria.

2. The method of claim 1 wherein comparing the list of locations comprises:
retrieving a radius focus point; and
reviewing the list of locations to determine if they are within an area associated with the radius focus point.

3. The method of claim 2 wherein retrieving a radius focus point comprises:
retrieving a location of a system which last communicated with the portable electronic device.

4. The method of claim 3 wherein the system is a cell tower, a WiFi router or a GPS location system.

5. The method of claim 1 further comprising:
expanding the predetermined criteria if no location is located with the predetermined criteria.

6. The method of claim 5 wherein expanding the predetermined criteria comprises expanding the area associated with the radius focus point.

7. The method of claim 1 further comprising:
displaying a list of locations which fit the predetermined criteria.

8. The method of claim 1 further comprising:
generating a database storing the list of locations before receiving the indication.

9. The method of claim 8 wherein generating the database comprises:
retrieving an location from a user's calendar application;
storing the retrieved location into the database.

10. The method of claim 8 wherein generating the database comprises:
receiving a location from user input; and
storing the received location into the database.

11. The method of claim 1 further comprising:
adding a weighting to locations in the list of locations; and
adjusting the weighting based on visits by a user to the locations in the list of locations.

12. The method of claim 1 further comprising:
receiving an indication that a user needs to be located before determining locations within the list of locations which fit the predetermined criteria.

13. The method of claim 12 further comprising:
gathering the list of locations before receiving the indication that the user needs to be located.

14. The method of claim 1 wherein the list of locations are separated into a list of addresses and a list of location co-ordinates.

15. The method of claim 14 wherein some of the addresses within the list of addresses include suite information for the address.
